(19) United States
(12) Patent Application Publication
(10) Pub. No.: US 2026/0193906 A1
(43) Pub. Date: Jul. 9, 2026

(54) ADJUSTABLE ANTI-THEFT DEVICE

(71) Applicant: CHECKPOINT SYSTEMS, INC., Thorofare, NJ (US)

(72) Inventors: Stuart Rosenthal, Howell, NJ (US); Daniel Escalante, Barcelona (ES); Leo Yang, Nantong (CN)

(21) Appl. No.: 19/132,527

(22) PCT Filed: Nov. 29, 2023
(86) PCT No.: PCT/US2023/081525

§ 371 Date: May 23, 2025

Related U.S. Application Data
(60) Provisional application No. 63/428,549, filed on Nov. 29, 2022.

(51) Int. Cl. E05B 73/00

(52) U.S. Cl. CPC E05B 73/0017

(57) ABSTRACT

A security device is shown and described herein. The security device is configured to engage with an item such as a container to be securely fitted around the container. The security device includes an adjustable back plate with corner sections disposed at opposite ends. The corner sections are configured to fit around a corner of a container or item. The corner sections can swivel or rotate such that they may be used on items of different dimensions. The corner sections are also adjustable in height to accommodate containers of different thicknesses.

### CROSS-REFERENCE TO RELATED APPLICATIONS

The present application claims priority to and the benefit of U.S. Provisional Application No. 63/428,549 entitled “Corner Keeper” filed on Nov. 29, 2022, the disclosure of which is incorporated herein by reference in its entirety.

### FIELD OF INVENTION

The present invention relates to a security device. In particular, the present invention relates to a security device suitable for protecting against the theft of boxed goods or their contents.

### BACKGROUND

Retail stores have a difficult time protecting boxes containing various expensive merchandise, books, and other similarly structured packages, or protecting such containers from being opened and the contents thereof being removed without authorization from store personnel or damaged while on display. Consumers often want to visually inspect the packaged expensive articles before deciding to purchase them. The store is faced with the problem of how to protect these expensive articles from theft while displaying them for sale.

One method used to protect these packages and the articles contained therein is to enclose the article within a transparent glass display case that can only be accessed by an authorized clerk. The consumer can view the article through the glass but is not able to handle the article or read any of the information about the article that may be printed on the box unless a store clerk removes the article from the case. However, in large retail stores, the problem then arises of getting the selected merchandise to the customer after the customer wishes to purchase the same without subjecting the merchandise to theft. One manner is to maintain a supply of the boxes containing the expensive articles or merchandise close at hand for delivery to or pick-up by the customer for subsequent taking to a check-out clerk. This, however, makes the boxes susceptible to theft and requires additional sales personnel.

A number of security devices are available to individually secure packages. A keeper box is a type of security device configured to house a product within the box. The keeper box is locked and may contain an EAS security device to trigger an alarm if the keeper box crosses a threshold location in the store (e.g., typically at or near a checkout or store exit). The keeper box may be made of clear plastic to allow customers to view the product. After a customer purchases the product, cashier or other store personnel can unlock the keeper box and remove the product from the keeper for the customer. For aesthetics and to limit damage to the product package from shifting or severe movements within the keeper, keeper boxes are generally provided with dimensions only slightly larger than the product package to be secured in the keeper. Thus, while capable of reuse, a keeper box may only be practically useable for products of certain dimensions.

Another known way to attach a hard EAS tag to an article is to use cables that pass around the article. Typically in these systems, the cables are tightened around the article and the tag is them activated. Once activated, the cables cannot be loosened or cut without triggering an alarm, thereby preventing unauthorized removal of the tag from the object.

Alarming tags adhered to the package and tamper labels are still other alternatives to providing anti-theft security protection to package containers.

Theft of expensive boxed goods may be for personal use, but in many instances, theft of expensive boxed goods is for resale such as on internet auction sites or on the black market. Damage to the product packaging reduces the product's resell value.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a security device suitable for protecting against theft of a product (e.g., merchandise, inventory) or item (e.g., money, precious metals) housed in a container. The security device is adjustable and configured to be employed on containers of different dimensions or profiles including items of shapes, lengths, and thicknesses. The security device is also reusable and following use on one container can be used on another container of the same or different dimensions. In one embodiment, the security device is also modular and components can be changed out to be useful with items of yet other size dimension ranges.

Provided, in one aspect, is a security device comprising a back plate having a first end and a second end, a first corner section connected to the first end of the back plate, and a second corner section pivotally connected to the second end of the back plate, wherein each corner section is configured to receive a respective corner of an item to be secured.

In one embodiment, the first and second corner sections are configured to pivot about first and second pivots disposed in a common plane.

In one embodiment, the common plane is defined by a longitudinal axis of the back plate and a transverse axis perpendicular to the longitudinal axis.

In one embodiment, the back plate comprises a first section and a second section, wherein the second section is telescopically received by the first section.

In one embodiment, the back plate comprises a first section in sliding engagement with a second section, wherein the first section and the second section cooperate to adjust a length of the back plate.

In one embodiment, the back plate includes a locking assembly configured to lock a position of the second section relative to the first section.

In one embodiment, a plurality of teeth are disposed on a surface of the second section, and a spring biased member is disposed on a surface of the first section, wherein the spring biased member is configured to engage the teeth to lock a position of the second section relative to the first section.

In one embodiment, the spring biased member comprises a ferrous material that is attractable to a magnet such that the spring biased member is deflected away from the teeth when subjected to a magnetic field created by a magnet.

In one embodiment, the respective corners are disposed at opposing ends of a diagonal therebetween.

In one embodiment, the first corner section and the second corner section each comprise an upper section and a lower section defining an opening configured to receive the respective corner of the item to be secured.

In one embodiment, one of the upper section and the lower section comprises a rail, and the other of the upper section and the lower section comprises a track or groove, wherein the rail is configured to move in the track or groove to adjust a height of the opening.

In one embodiment, the corner section includes a plate comprising a first plurality of teeth, and the rail comprises a second plurality of teeth configured to engage the first plurality of teeth to lock the height of the opening.

In one embodiment, the upper section slidingly engages the lower section such that a height of the respective first and second corner sections is adjustable.

In one embodiment, the back plate defines a housing, the housing being dimensioned to accommodate at least one of a ferrite rod, an EAS tag, an AM tag, a RF tag, a sensor, and a magnet.

Provided in another aspect, is a security device comprising a back plate having a first end and a second end. A first corner section is removably attached to the first end of the back plate, and a second corner section is removably attached to the second end of the back plate. The first corner section defines a first opening to receive a first corner of the container, and the second corner section defines a second opening to receive a second corner of the container disposed at a diagonal relative to the first corner. A first locking assembly is configured to lock a height of the first corner section and a second locking assembly is configured to lock a height of the second corner section.

In one embodiment, the first and second corner sections each comprise a plurality of teeth disposed at opposite ends thereof configured to engage a container secured by the security device.

In one embodiment, the first and second corner sections each include an upper section and a lower section, wherein one of the lower section and the upper section slidably receives the other of the lower section and the upper section to adjust a respective height of the first and second corner sections.

In one embodiment, the first and second corner sections each include an upper section and a lower section, and wherein the first and second locking assemblies each include a plate, wherein one of the upper section and the lower section defines a first plurality of teeth and the plate defines a second plurality of teeth configured to engage the first plurality of teeth when the container is received by the security device to lock the container in place.

In one embodiment, each plate includes a protrusion configured to engage the container to urge the second plurality of teeth into engagement with the first plurality of teeth.

In one embodiment, the first and second locking assemblies each include a bracket assembly, wherein the plates and the bracket assemblies are respectively urged forward and upward when the container is removed from the security device to disengage the upper section from the lower section.

In one embodiment, the first and second locking assemblies each include first and second biasing elements configured to respectively urge the plates and the bracket assemblies forward and upward to disengage the second plurality of teeth from the first plurality of teeth.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a perspective view of a security device in accordance with an embodiment of the invention;

FIG. 2 is a perspective view of a security device in accordance with an embodiment of the invention;

FIG. 3 is a top plan view of a security device in accordance with an embodiment of the invention;

FIG. 4 is a side view of a security device in accordance with an embodiment of the invention;

FIG. 5 is a bottom plan view of a security device in accordance with an embodiment of the invention;

FIG. 6 is a top plan view of a security device in accordance with an embodiment of the invention;

FIG. 7 is a bottom plan view of a security device in accordance with an embodiment of the invention;

FIG. 8 is a side view of a security device in accordance with an embodiment of the invention;

FIG. 9a is a view of a corner section of a security device positioned at a first height;

FIG. 9b is a view of the corner section of the security device of FIG. 9a positioned at a second height;

FIG. 9c is a view of the corner section of the security device of FIG. 9a positioned at a third height;

FIG. 10a is a view of the corner section of a security device positioned at a first height;

FIG. 10b is a view of the corner section of the security device of FIG. 10a positioned at a second height;

FIG. 10c is a view of the corner section of the security device of FIG. 9a positioned at a third height;

FIG. 11 is a perspective view of a back side of a container having a security device in accordance with the invention attached thereto;

FIG. 12 is s perspective is a front view of a container having a security device in accordance with the invention attached thereto;

FIG. 13 is a perspective view of a back side of a container having a security device in accordance with the invention attached thereto

FIG. 14a is a perspective exploded view of a corner section in relation to a section of the back plate;

FIG. 14b is a side exploded view of a corner section in relation to a section of the back plate;

FIG. 14c is a side view of the security device showing a cross-section of the connection of a corner section and a section of the back plate;

FIG. 15a is a perspective view of an underside of the second section of the back plate;

FIG. 15b is a perspective view of the first section of the back plate;

FIG. 15c is a perspective view of the first section of the back plate with the spring biased member;

FIG. 15d is a cross-sectional view of the first section and the second section of the back plate in engagement with one another;

FIG. 16a is a side view of a corner section of the security device;

FIG. 16b is a back view of a plate from a corner section of the security device; and

FIG. 16c is a cross-sectional view of a corner section of the security device;

FIG. 17 is a perspective view of a security device securing a container in accordance with another embodiment;

FIG. 18 is a perspective view of the security device of FIG. 17 with the container removed;

FIG. 19 is a perspective view of an example corner section in accordance with another embodiment provided with an example bracket assembly in accordance with an embodiment;

FIG. 20 is a partial, exploded view of the corner section and the bracket assembly of FIG. 19;

FIG. 21 is a partial, bottom exploded view of the corner section of FIG. 19 shown without the bracket assembly;

FIG. 22 is a perspective view of the bracket assembly of FIG. 19 shown in relation with an example plate in accordance with an embodiment;

FIG. 23 is a partial, perspective view of the corner section of FIG. 19 shown in relation with example guide pins and an example rest of the bracket assembly of FIG. 19;

FIG. 24A is a partial, section view of the plate of FIG. 22 shown in relation to a wall of the corner section;

FIG. 24B is a rear, perspective view of the plate of FIG. 22 attached to a wall of the corner section;

FIG. 24C is a rear, perspective view of the wall of FIG. 24B shown without the plate;

FIG. 25A is a partial, section view of the plate and the bracket assembly shown in an engaged or locked configuration;

FIG. 25B is a partial, section view of the plate and the bracket assembly shown in a disengaged or unlocked configuration;

FIG. 25C is a partial, section view of the bracket assembly of FIG. 19 shown in relation to an example biasing element;

FIG. 25D is a partial, perspective view of a wall of the corner section shown in relation to biasing elements;

FIG. 26A is a bottom, perspective view of a lower section of the corner section in accordance with an embodiment;

FIG. 26B is an upper, perspective view of an end of a back plate in accordance with an embodiment.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a security device suitable for protecting against theft of an that generally has opposing corner such as a rectangular product, e.g., a book, box, or other such type of container. The security device is adjustable to be employed on items of different shapes, sizes, and/or different thicknesses. Additionally the device is reusable and following use on one container can be used on another item of the same or different dimensions. The security device can also be modular allowing for certain components to be changed out if damaged or to provide a component that may be better suited on an item of a different dimension range.

Provided in one aspect is a security device comprising an adjustable back plate having a first end and a second end, a first corner section disposed at the first end of the back plate, and a second corner section disposed at the second end of the back plate. The first and second corner sections are free to rotate in a common plane. The device is adjustable in several aspects including: (i) in length as the back plate can be shortened or lengthened along its longitudinal axis; (ii) in height as the height of the corner sections are adjustable in a vertical plane to be secured around different items having different thicknesses; and (iii) in angle of the corners relative to one another as the corner sections can rotate to change the angle, which allows for securing devices of different lengths, widths, and thicknesses.

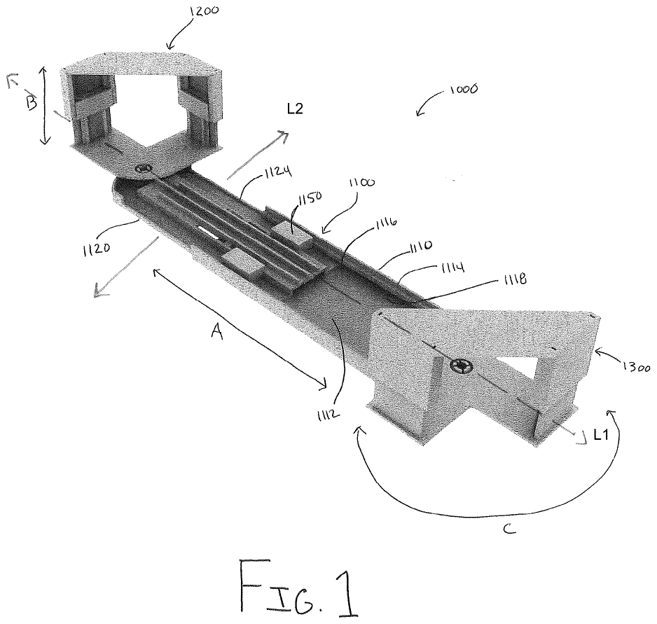

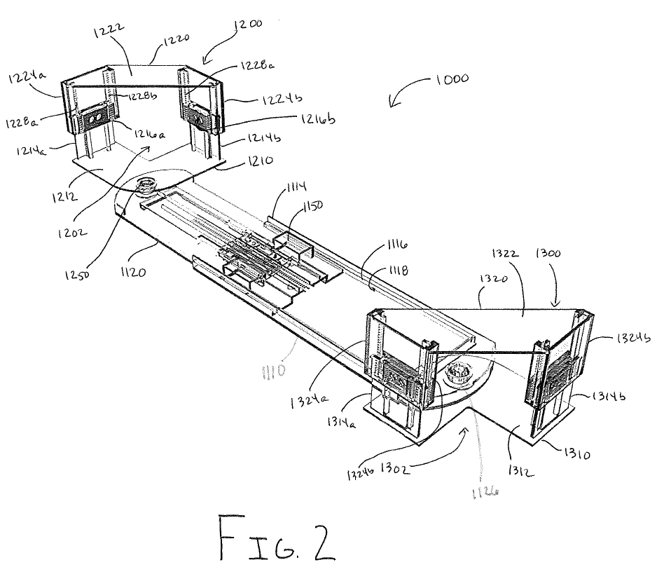

FIGS. 1-13 show an embodiment of a security device in accordance with aspects and embodiments of the invention. The devices in FIGS. 1-13 generally have the same configuration, unless otherwise noted, except that some may depict a device formed with a clear plastic body, and others may depict the device with an opaque plastic body. In embodiments, the components of the security device described herein may alternatively be made of metal.

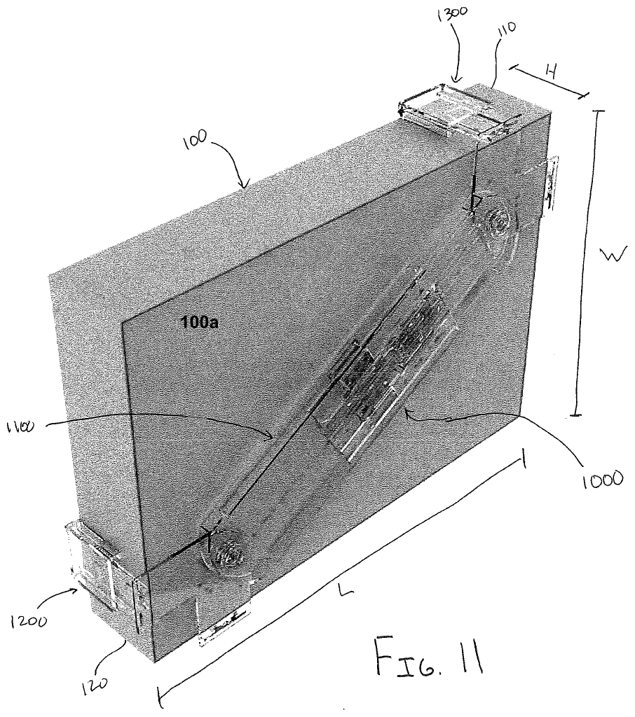

The security device 1000 includes a back plate 1100, a corner section 1200 disposed adjacent a first end 1102 of the back plate, and a corner section 1300 adjacent a second end 1104 of the back plate 1100. The corner sections 1200, 1300 are configured to securely fit and retain an item 100 (e.g., a container or other product) having length L, width W, and height H, receiving two opposite vertices or corners 110 and 120 of the item through an opening 1202 and 1302 of the respective corner sections (FIGS. 11-13). In the embodiment shown, the corner sections 1200, 1300 are disposed at two opposite corners 110, 120 of the item 100 connected by a diagonal. In other embodiments, it is contemplated that the corner sections may be disposed in other locations, e.g., at the exposed corners of the container. In some embodiments, another back plate may extend about an opposite planar surface 100b (FIG. 12) of the item 100 (e.g., opposite a first planar surface 100a (FIG. 100a).

The back plate 1100 has a length that is adjustable in a direction A (FIG. 1) that is parallel to a longitudinal axis (axis L1 in FIG. 6) of the back plate 1100. The back plate 1100 comprises a first section 1110 and a second section 1120 in sliding engagement with one another. The length of the back plate 1100—and the security device 1000—is adjusted by sliding the first section 1110 and the second section 1120 relative to one another. The first and second sections 1110 and 1120 can be shaped or configured in any manner as desired to provide the sliding engagement. The first section 1110 generally comprises a floor surface 1112 and sidewalls 1114 extending upward from the floor surface 1112. The outer surface of the second section 1120 is configured to fit within the first section 1110 and slide along walls 1114. In the embodiment of FIGS. 1-13, the walls 1114 of the first section 1110 include a tab or projection 1116 extending radially inward of the walls 1114. A space 1118 is defined between the tab/projection 1116 and the floor surface 1112, the space 1118 configured to receive the second section 1120, e.g., wall 1124 thereof. The tabs 1116 may keep the first and second sections 1110 and 1120 from disassociating with one another in the vertical plane.

The first and second sections 1110 and 1120 forming the back plate 1100 can be configured in any suitable manner as desired to provide the sliding engagement of the first and second sections 1110 and 1120. One of the first or second section 1110 or 1120 could be shaped to include any number of slots and tabs or projections dimensioned to run or otherwise slide in or along grooves formed in the other of the first or second section 1110 or 1120, e.g., a rail system, etc.

The back plate 1100 configuration provides the security device 1000 with adjustability in length to accommodate a variety of diagonal lengths on different sized items or containers.

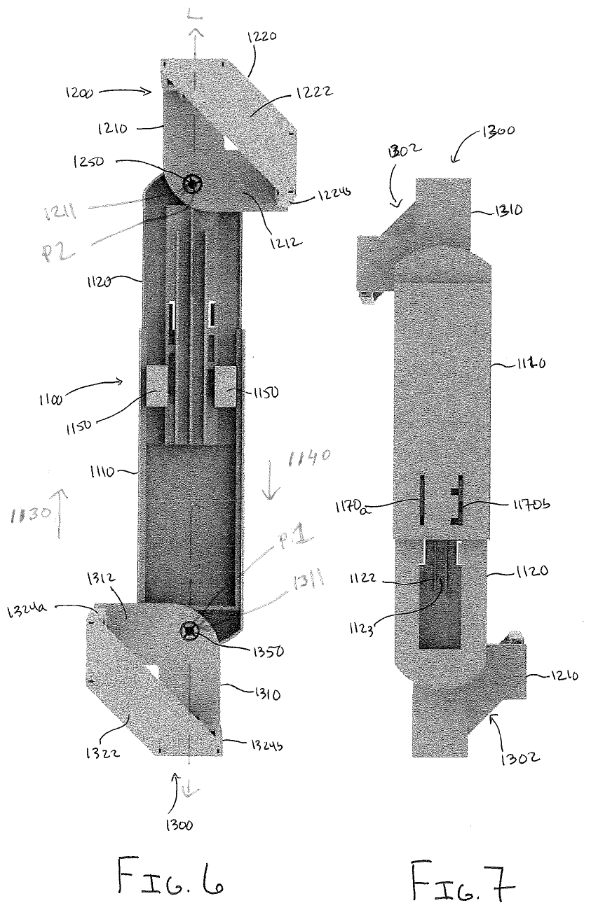

The corner sections 1200 and 1300 are configured to be fitted around or receive a corner of a package or container (e.g., 100 in FIG. 12) or any item having opposing corners. The corner sections 1200 and 1300 include lower sections 1210 and 1310 and upper sections 1220 and 1320 defining openings 1202 and 1302 configured to receive a corner of an item. The upper and/or the lower sections 1220 and 1320 may also include structure (e.g., protrusions) to contact the item, as discussed in detail below. The lower sections 1210, 1310 have a base surface 1212, 1312, and a cover element 1222 (FIG. 2), respectively. The lower sections 1210, 1310 of the corner sections 1200, 1300 are configured to be connected to respective ends of the back plate 1100 such that the corner sections 1200, 1300 can rotate or swivel. The lower sections 1210, 1310 can be connected to the back plate 1100 in any suitable manner such as via a connector pin (e.g., 1250, 1350 in FIGS. 6 and 7) or other suitable connection. In one embodiment, the attachment can be provided such that the corner sections 1200, 1300 are removable from the security device 1000 if desired. For example, it may be desirable to remove or change the corner sections 1200, 1300 if the corner sections 1200, 1300 need to be switched out due to damage or to provide other corner sections of different profiles or sizes to be used with items of different profiles/sizes.

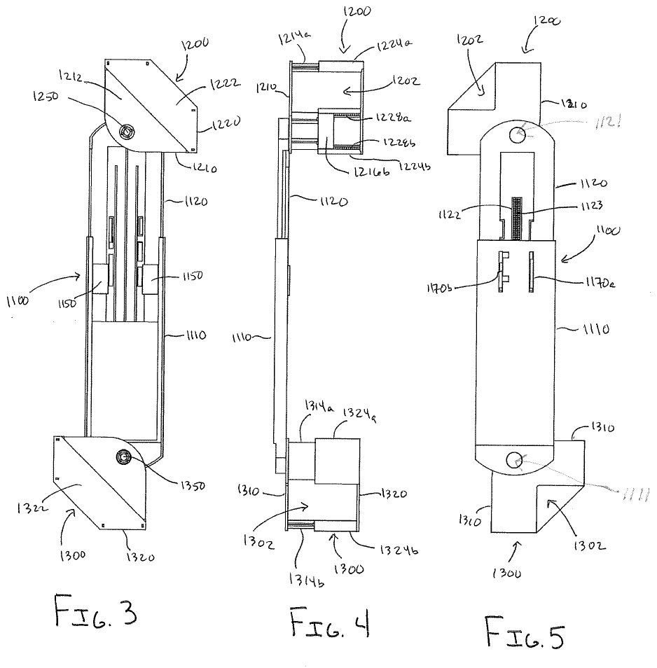

In one embodiment, referring to FIGS. 5 and 6, the lower sections 1210, 1310 of the corner sections 1200, 1300 could contain openings 1211, 1311 (FIG. 6) configured to align with corresponding openings 1121, 1111 (FIG. 5) at respective ends of the back plate 1100 for receiving connector pins 1250, 1350 therethrough, respectively. The connector pins 1250, 1350 could optionally be removable from the security device 1000 to accommodate changing out the corner sections 1200, 1300.

In embodiments, the corners sections 1200, 1300 are attached to the first and second sections 1110, 1120 via connectors 1250, 1350 that allow the corner sections 1200, 1300 to swivel or rotate about pivots P1, P2 disposed in a plane defined by the longitudinal axis L1 (FIG. 1) and a transverse axis L2 (FIG. 1) perpendicular to the longitudinal axis L1 (FIG. 1) of the back plate 1100. The corner sections 1200, 1300 can be connected to the back plate 1100 using any suitable connector or mechanism to achieve such movement. For example, a pivot pin may be inserted through the openings 1211 and 1311 of the corner sections 1200, 1300 and into the corresponding openings 1121, 1111 of the first and second sections 1110, 1120. Utilizing connectors or pivot pins allow the corner sections 1200 and 1300 to rotate in a horizontal plane of the security device 1000 defined by the longitudinal L1 axis of the back plate 1100, and the transverse axis L2 perpendicular to the longitudinal axis L1 (see rotation direction C in FIG. 1).

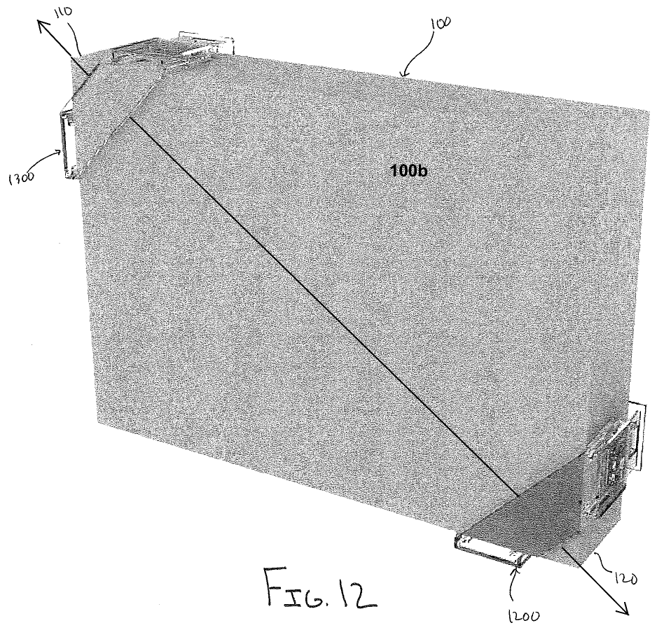

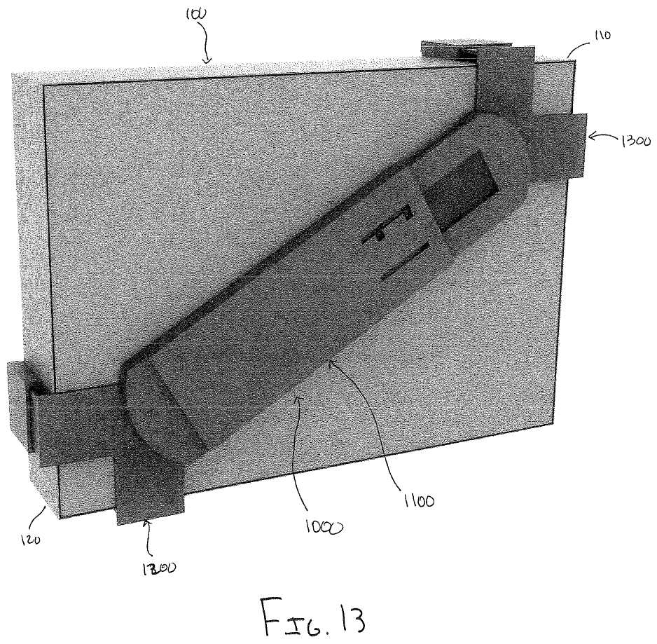

Referring to the embodiments shown in FIGS. 1-10 and FIGS. 14a-c, as previously noted, the corner sections 1200, 1300 and the first and second sections 1110, 1120 may have openings 1211, 1311 and 1121, 1111 configured to receive connector pins 1250 to allow movement of the corner sections 1200, 1300. Reference will specifically be made to corner section 1200 and the second section 1120, but it will be appreciated that the corner section 1300 and the first section 1110 may also have a similar system for allowing movement. The second section 1120 of the back plate 1100 includes a receptacle 1125 (FIG. 14A) defining an opening 1121 dimensioned to receive a pin 1250 (pin 1350 for corner 1300), and the corner section 1200 includes a receptacle 1260 defining an opening 1211. The openings 1121 and 1211 are aligned with one another, and the pin 1250 is inserted into the openings 1121 and 1211. Receptacle 1260 is configured with a concentric opening 1211 such that the opening 1211 defines a ledge 1264. Pin 1250 includes a body 1252, a base 1254, and a head 1256. The head 1256 is configured to have a ledge or overhang such that when the pin 1250 is inserted through the opening 1211 the overhanging portion of the head 1256 engages the ledge 1264 to provide a snap fit. The pin 1250 includes slots 1258 that allow the head 1256 and the body 1252 to be slightly compressed when being inserted into the opening 1211 and then expand to engage the ledge 1264. The pin 1250 can be removed by compressing the head 1256 so that the overhanging edge of the pin 1250 can be squeezed through the opening 1211. The receptacle 1125 can define a concentric opening 1121 so as to define a ledge 1129 (FIG. 14C) that may be sized to receive the base 1254 (FIG. 14B) of the pin 1250.

While the pin 1250 is shown as a separate piece, it will be appreciated that the pin 1250 could be integral with the second section 1120. In such an embodiment, the second section 1120 would not have a separate receptacle 1125 or opening 1121, but the pin 1250 to be inserted in to the opening 1211 of the corner section 1200 may be molded as part of the second section 1120. In another embodiment, the pin 1250 could be integral with the base surface 1212 of the corner section 1200 and be configured to snap into the receptacle 1125. The openings 1211 and 1111 align with openings of the receptacles 1125 and 1126 adjacent the ends of the second section 1120 and the first section 1110, respectively, of the back plate 1100.

The back plate 1100 can include a system for locking the first and second sections 1110 and 1120 to prevent them from freely sliding relative to one another and to hold them in a desired fixed position. This can prevent the security device 1000 from being “opened” to allow removal of the item being contained until desired such as after a sale has been made. In one embodiment, the locking system can be provided by a locking assembly for locking the second section 1120 in a selected position relative to the first section 1110. In this regard, the locking assembly may be configured to permit sliding of the first section 1110 in a closing sliding direction 1130 to close or reduce the length of the back plate 1100 and tighten the security device 1000 about an item, but prevent sliding of the first section 1110 in the sliding direction 1130 to prevent extending the length of the back plate 1100 to “open” the security device 1000 and allow for removal of the item to be protected.

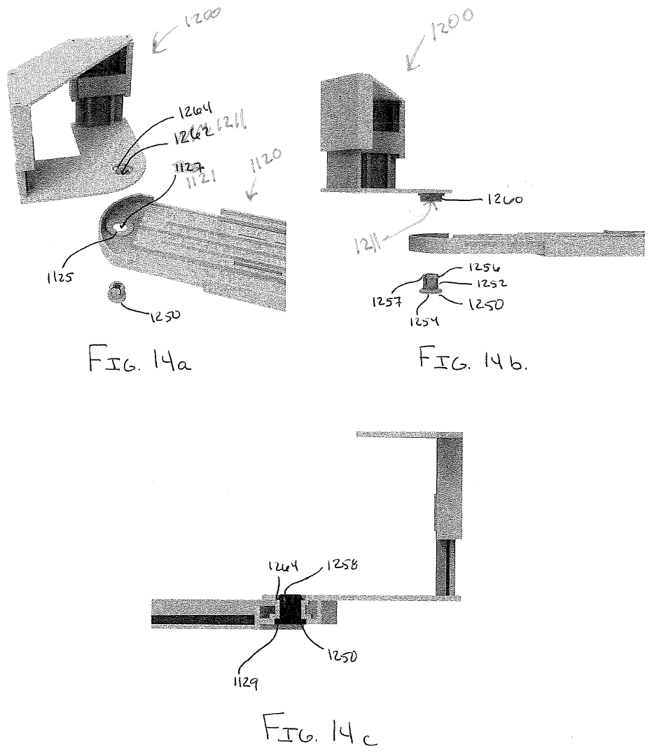

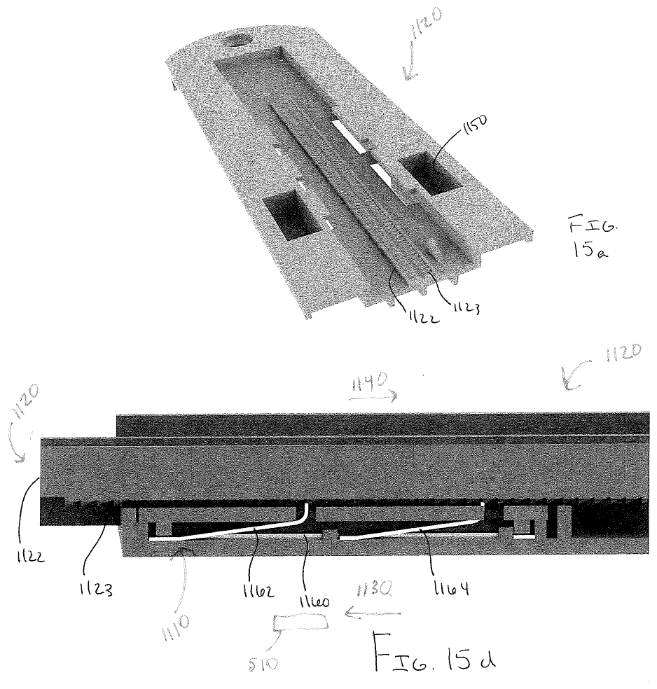

The locking assembly may include a rail 1122 (FIG. 15A) comprising teeth 1123 disposed on a surface of the second section 1120 and oriented toward a surface of the first section 1110, and a spring biased member 1160 (FIG. 15D) configured to engage the teeth 1123. The spring biased member 1160 may be any member configured with one or more spring members that have an elasticity such that the spring member(s) 1160 may tend to revert back into an original position after being deflected out of the engagement position. According to some example embodiments, the teeth 1123 may be angled relative to the spring biased member 1160 in a manner that permits the spring biased member 1160 and the first section 1110 to move freely in the sliding direction 1130 thereby “closing” the security device 1000 by shortening the length of the back plate 1100, but causes the spring biased member 1160 to catch or interlock with the teeth 1123 and prevent movement of the first section 1110 in the sliding direction 1140 that would increase the length of the back plate 1100, when the spring biased member 1160 is in an extended position.

According to some example embodiments, the spring biased member 1160 comprises a leaf spring. In the embodiment shown in FIGS. 15b-15d, the spring biased member 1160 includes two spring members 1162 and 1164. The spring biased member 1160 is disposed in a slot 1180 (FIG. 15C) of the first section 1110. The spring biased member 1160 may be comprised of a ferrous material such that the spring members 1162, 1164 are attracted to a magnet and therefore deform (e.g., becomes compressed) when subjected to a magnetic field. In this regard, when the spring biased member 1160 is subjected to a magnetic field created by a magnet of a detacher key inserted into slots 1170a and 1170b (FIG. 7) of the first section 1110, the spring member(s) 1162, 1164 (FIG. 15D) may deform or compress in the direction of the magnet 510 and move out of engagement with the teeth 1123 of the second section 1120. With the spring biased member 1160 deflected out of engagement with the teeth 1123, the first and second sections 1110 and 1120 may be free to move in both sliding directions 1130 and 1140 without being inhibited by the spring biased member 1160. Accordingly, by disengaging the spring biased member 1160, the detacher key permits the back plate 1100 to be slid in a sliding direction 1140, which increases the gap between the corner sections 1200 and 1300 to permit removal of an item. Together, the security device 1000 and the detacher key may form an example system, according to some example embodiments.

The adjustable back plate 1100 and rotatable corner sections 1200 and 1300 provide a security device 1000 that can be adjusted to the shape and dimensions of the container to which the security device 1000 is to be secured. The adjustable back plate 1100 allows for changing the length of the security device 1000 to accommodate the length (e.g., length L in FIGS. 11-13) of the container. The rotatable corner sections 1200 and 1300 allow for adjusting the angle of the back plate 1100 to fit containers of different widths (e.g., width W in FIGS. 11-13). This allows the security device 1000 to be employed on a variety of containers of different rectangular shapes (including thinner and wider shaped containers).

The corner sections 1200, 1300 are configured to be adjustable in height. The corner sections 1200, 1300 are adjustable in the plane B (FIG. 1), which is vertical or perpendicular to the longitudinal axis L1 of the back plate 1100. The corner sections 1200, 1300 may include vertical walls 1214a, 1214b (e.g., FIG. 2—for corner 1200) and 1314a, 1314b (for corner 1300) extending from the base plates 1212 and 1312 thereof, respectively. The walls 1214a and 1214b (forming part of a lower section 1210 of the corner section 1200) are in sliding engagement with walls 1224a and 1224b respectively of an upper section 1220, and walls 1314a and 1314b (forming part of a lower section 1310 of the corner section 1300) are in sliding engagement with walls 1324a and 1324b of an upper section 1320. The manner of engagement is not particularly limited. The walls 1224a, 1224b, 1324a, 1324b of the upper sections 1220, 1320 can each include a slot that can slide over the outer edge of the walls 1214a, 1214b, 1314a, 1314b of the lower sections 1210, 1310. In FIGS. 1-12, the lower sections 1210 and 1310 are formed or otherwise provided with plates 1216a, 1216b, 1316a, 1316b, and the respective upper sections are 1220 and 1320 are configured such that the walls 1224a, 1224b, 1324a, 1324b thereof define interior regions with edges configured to slidingly engage the outer edges of the plates 1216a, 1216b, 1316a, and 1316b of the lower sections 1210, 1310.

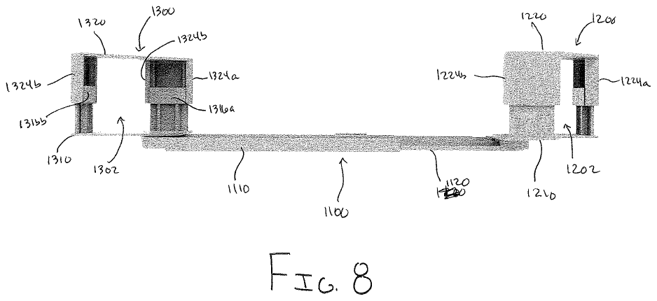

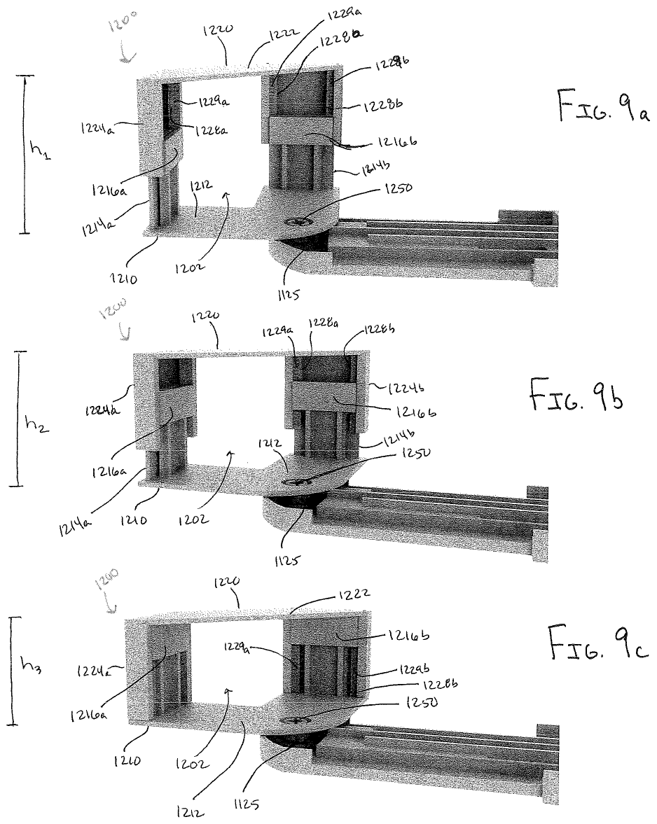

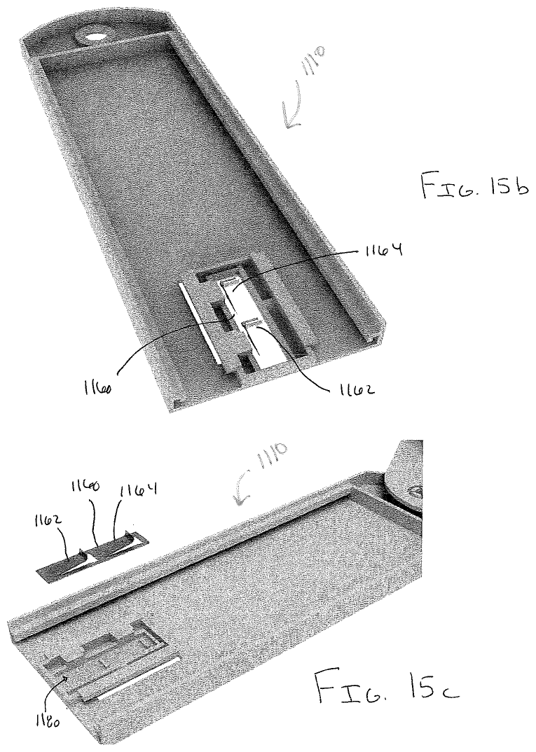

The corner sections 1200, 1300 are provided with a locking system to lock the height of the corner sections 1200, 1300 in place when fitted around a container. The locking system is not particularly limited and can be selected as desired to lock the corner sections 1200, 1300 in a position when surrounding a corner of a container and such that the height of the corner sections 1200, 1300 cannot be adjusted (e.g., increased) to expand when it is engaged with a container. As shown in FIGS. 1-10 and FIGS. 16a-c, the walls of the corner sections 1200, 1300 are provided with rails (e.g., 1228a and 1228b in FIGS. 9A-9C on the upper section 1220) having grooves or teeth (e.g., 1229a, 1229b, respectively). The plates (1216a, 1216b, 1316a, 1316b) include teeth 1217a (FIG. 16b) to engage the teeth/grooves 1229a (FIG. 16c) and lock the height of the corner section 1200. The teeth 1229a can be configured such that the upper section 1220 can be slid downward relative to the lower section 1210 but cannot be slid upward unless the plate 1216a is biased away from the wall 1224a of the upper section 1220 or removed from the corner section 1200. The plate 1216a can be clipped onto the wall 1214a via clips 1230a and 1230b into grooves 1235a and 1235b of the upper section 1220 respectively. The plate 1216a can include receptacles 1240a and 1240b configured to engage projections 1245a and 1245b formed on the corner section 1200 (e.g., the lower section 1210 thereof). The height of the corner section 1200 can be adjusted by biasing the lower section 1210 such that the plate 1216a is biased away from the teeth/grooves 1229a such that the upper section (1220, 1320) can be adjusted or slid relative to the lower section (1210, 1310). FIGS. 9a, 9b, and 9c show the corner section 1200 positioned at three different heights (h1, h2, and h3).

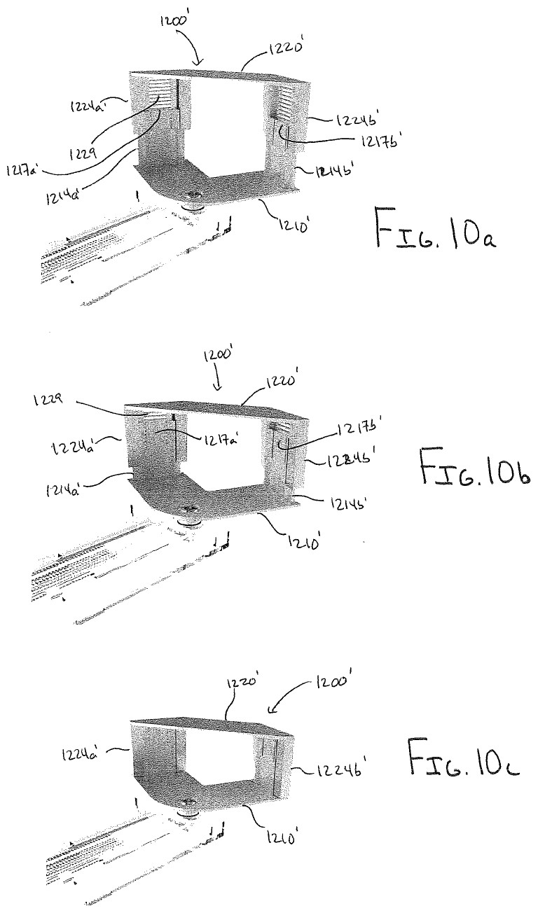

Other locking systems are contemplated for adjusting the corner sections 1200, 1300. As shown in FIGS. 10a-10c, the corner section 1200′ includes an upper section 1220′ and a lower section 1210′ in sliding engagement with each other. The locking mechanism includes a single row of teeth or grooves 1229′ in the walls 1224a′ and 1224b′. Walls 1214a′ and 1214b′ may include a latch having a tab 1217a′ and 1217b′ configured to engage with the teeth or grooved 1229′. Slightly biasing the upper section 1220′ from the lower section 1210′ allows sufficient disengagement of the tab 1217a′ and 1217b′ such that the upper and lower sections 1220′ and 1210′ can be slid relative to one another to adjust the height of the corner section 1200′.

The shape of the grooves or teeth can be shaped as desired to provide the desired level of engagement. While the teeth/grooves and corresponding plates or tabs to engage the teeth/grooves are shown as generally rectangular, it will be appreciated that the grooves/teeth could be circular or elliptical, and the corresponding plates or tabs could be provided as a cylinder or hemispherical shape sized to fit into the grooves/teeth.

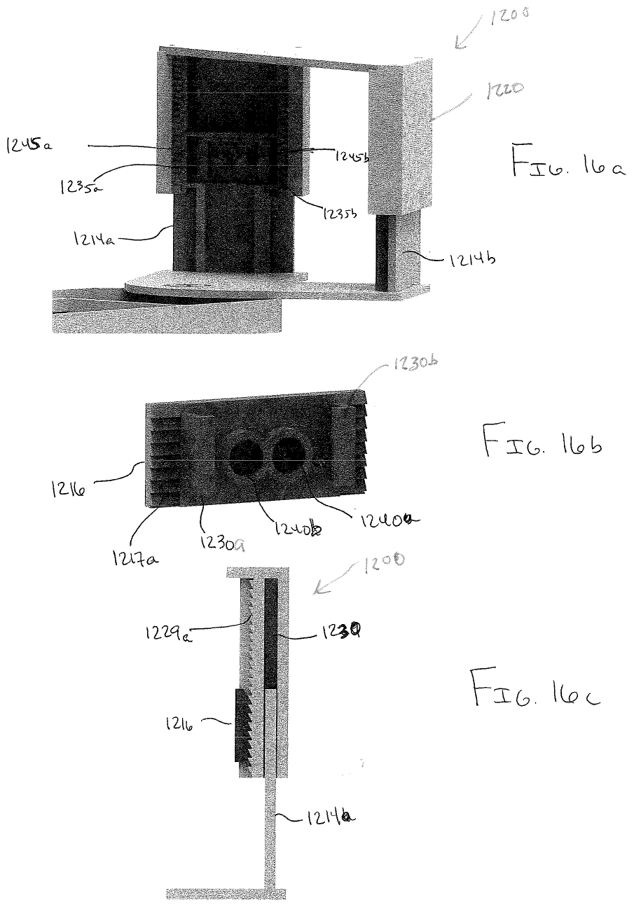

The security device 1000 can be configured with an alarm or an electronic article surveillance (EAS) feature such as an EAS system. In the embodiment shown (FIGS. 1 and 2), the second section 1120 of the back plate 1100 includes formed housings 1150 defining an opening or space configured to receive electronics or other components of an EAS system to provide security features to the security device. In embodiments, the opening or space can be configured to receive a ferrite rod as is used in EAS systems. The configuration and design of the electronic surveillance/security features is not particularly limited and can be selected as desired. For example, the housings 1150 may also accommodate an EAS tag comprising electronic elements including a resonant circuit of coil coupled to a capacitor. The circuit is tuned to a predetermined frequency and if one attempts to remove the hard tag containing these elements from a store, an alarm triggers as the tag passes through a surveillance field created by a transmitter and receiver located between pedestals at the store exit, tuned to the same frequency. The alarm goes off as the EAS tag resonates, providing an output signal detected by a receiver, also located in the pedestals. The housings 1150 may also accommodate an AM tag that is magnetized or affixed with particular circuitry such that when the tag meets an emitted tonal burst from a tag detector, the tag resonates to activate the tag to set off an alarm at the detector. Additionally, the housings 1150 may accommodate a RF tag affixed with an inductor/capacitor (LC) circuit which alarms at a detector sweeping for the resonant frequency of the tag. The same principal may apply to AM tags affixed with an LC circuit. In some embodiments, the respective first and second sections 1110, 1120 may each comprise a housing accommodating components of an anti-tamper buzzer or alarm that sounds if the security device 1000 is forced open or damaged, for example, if the first section is broken away from the second section. For example, one housing may accommodate a magnet, and the other may accommodate a sensor that signals to actuate the buzzer or alarm if the first section is spaced away from the second section at a predetermined distance in a vertical direction (e.g., along a z axis (FIG. 17).

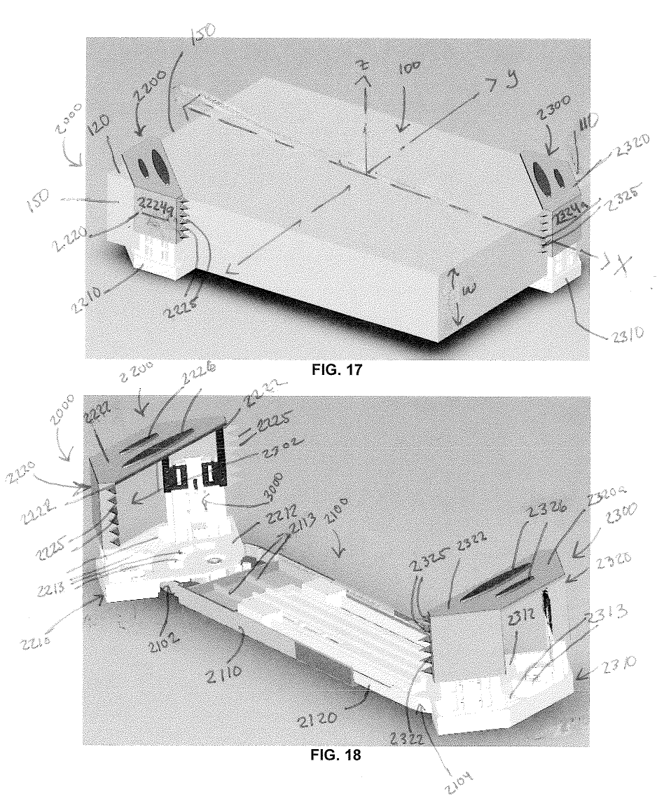

Turning now to FIGS. 17-27, another example of a security device 2000 is shown. The security device 2000 includes features that are substantially similar to the security device 1000 described above. Accordingly, a detailed description of similar features has been omitted for brevity, except for the differences noted below. Referring to FIGS. 17 and 18, the security device 2000 includes corner sections 2200, 2300 that are pivotally and removably coupled to opposing ends 2102, 2104 of a back plate 2100. The corner sections 2200, 2300 include lower sections 2210, 2310, upper sections 2220, 2320, and locking assemblies comprising bracket assemblies 3000 and plates 3050 configured to lock or secure the lower sections 2210, 2310 to the upper sections 2220, 2320 (and corresponding heights of the corner sections) when a container 100 is received by the security device 2000, as discussed in detail below.

A plurality of teeth 2225, 2325 are formed on opposite ends 2222, 2322 of the upper sections 2220, 2320, respectively. The teeth 2225, 2325 are configured to engage the container 100, for example, in embodiments where the container 100 is made of cardboard, corrugated fiberboard, or plastic. In this aspect, the teeth 2225, 2325 are configured to secure the container 100 (e.g., by gripping it) when engaged therewith, thereby making it more difficult to remove the container 100 when the security device 2000 is in a locked configuration. Further, the teeth may damage the package if attempts are made to forcibly remove it from the security device.

One or more strips 2226, 2326 may be attached (e.g., adhered) to upper surfaces of the upper sections 2220, 2320 (e.g., to the cover elements 2222, 2322 thereof), or to lower surfaces of the lower sections 2210, 2310 (e.g., to the base plates 2212, 2312 thereof) The strips 2226, 2326 may be made of a high friction material (e.g., rubber or silicone) to prevent the security device 2000 from slipping or sliding, for example, when a plurality of security devices 2000 are arranged in a stacked arrangement.

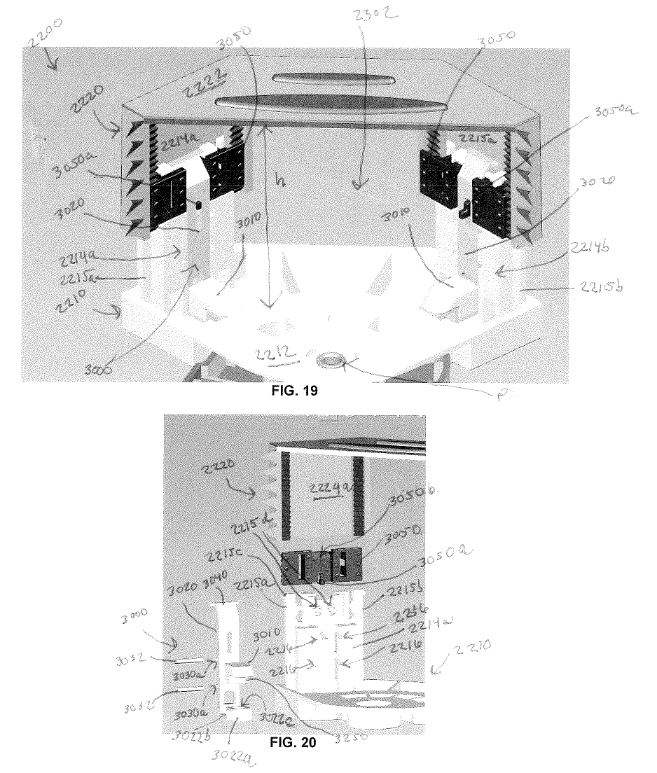

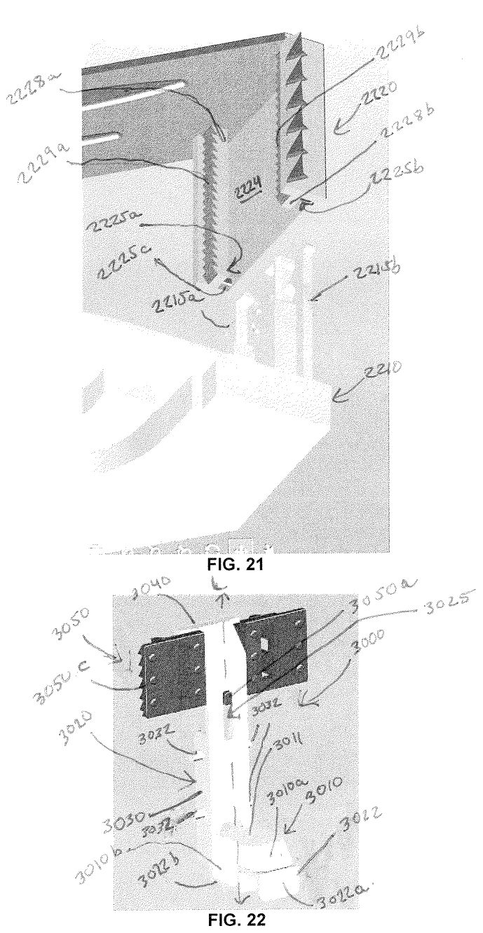

Referring to FIGS. 19-25D, the corner section 2200 will now be described. It should be appreciated that the following description also applies to the corner section 3200. As shown in FIGS. 19 and 20, the lower and upper sections 2210, 2220 are configured to move relative to each other in a vertical direction, for example, when it is desired to adjust the height h of the corner section 2200 (and thus the opening 2302 thereof) based on the corresponding width w (FIG. 17) of the container 100 received by the corner section 2200. For this purpose, the walls 2214a, 2214b of the lower section 2210 may define one or more rails 2215a, 2215b dimensioned to slide within or engage tracks or grooves 2225a, 2225b (FIG. 21) defined by a wall 2224a and rails 2228a, 2228b of the upper section 2220. In the embodiment shown, a stop 2225c (FIG. 21) is disposed at a distal end of track 2225a. It is contemplated that the stop 2225c may be disposed at a distal end of track 2225b. In embodiments, the stop 2225c is configured to engage with a catch 2215c (FIG. 20) disposed at a distal end of the rail 2215a of the lower section 2210 to inhibit the upper section 2220 from disengaging the lower section 2210. In the embodiment shown, the lower section 2210 comprises a rail, and the upper section 2220 comprises tracks or grooves. It is contemplated that the lower section may instead define the tracks or grooves, and the upper section may define the rails. In this manner, it should be understood that a wide variety of configurations are contemplated without departing from the scope of the present teachings.

Referring to FIGS. 19, 20, and 22, each bracket assembly 3000 includes a rest 3010 and a bracket or upright 3020. The upright 3020 includes a leg 3022 extending inward (e.g., toward a pivot P) in a direction perpendicular to a longitudinal axis L of the upright 3020. The leg 3022 includes a first portion 3022a and a second portion 3022b that is stepped down relative to the first portion 3022a. The first portion 3022a defines a through hole 3022c that is dimensioned to receive a pin 3250 protruding downward from a first portion 3010a of the rest 3010 configured to attach the rest 3010 to the upright leg 3022. The pin 3250 may include a head (e.g., like 1256 in FIG. 14B) that is dimensioned slightly larger than the through hole 3022a, such that when the head is compressed, it may be urged through the through hole 3022a and expanded (upon being uncompressed) to secure the pin 3250 to the leg 3022, e.g., to prevent the pin 3250 from freely retracting out of the through hole 3022a. The second portion 3022b of the leg 3022 is recessed relative to the first portion 3022a and is dimensioned to receive and accommodate a second portion 3010b of the rest 3010. In use, an upper surface 3011 of the rest 3010 is configured to receive a respective edge of the container 100 (FIG. 17) thereon. For this purpose, the first portion 3022a may define an inclined contour to more easily bring about a respective edge of the container 100 onto the upper surface 3011 of the rest 3010. In the embodiment shown, the rest 3010 is a separate component from the leg 3022. It is contemplated that the 3010 may be integrally formed with the leg 3022 as one component instead.

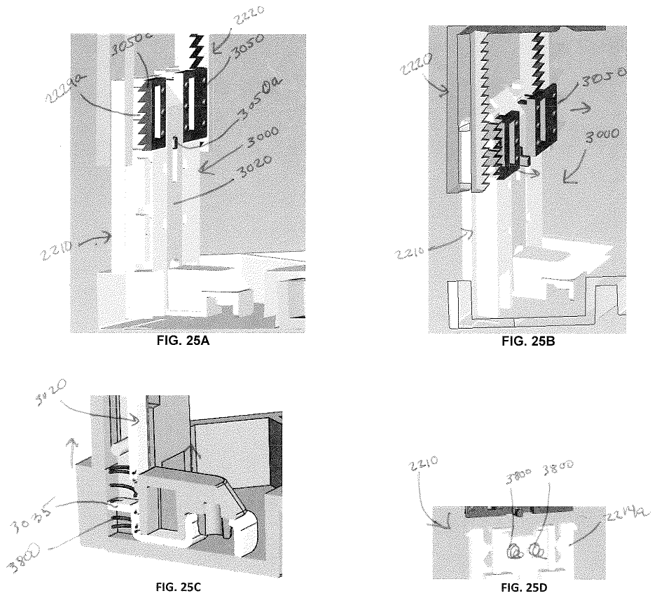

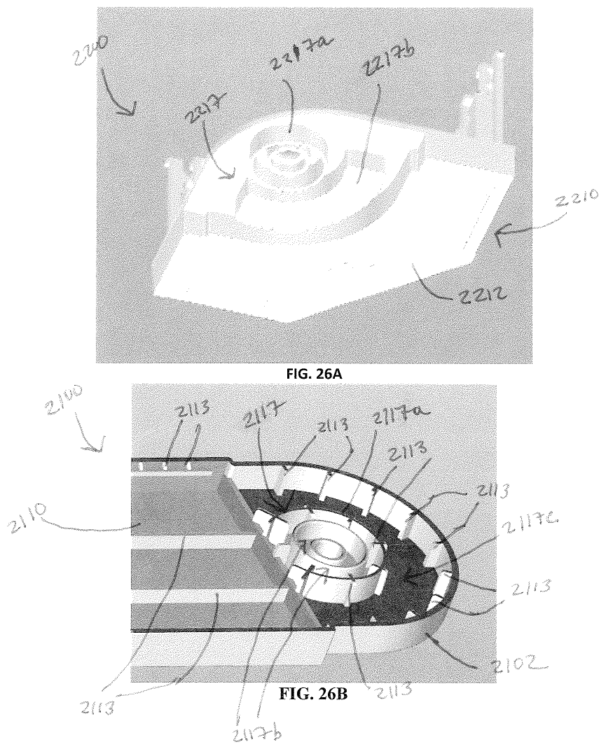

The upright 3020 may also include a pair of flanges 3030 extending rearward along a partial length thereof, and a retainer 3040 protruding rearward from an upper end thereof. Each flange 3030 may define one or more through holes 3030a extending therethrough in a direction perpendicular to the longitudinal axis L of the upright 3020. Each through hole 3030a is dimensioned to receive a guide pin 3032 that is inserted into a respective opening 2216 of the wall 2214a of the lower section 2210. The guide pins 3032 are configured to slide about rails 2218 formed in between front and rear surfaces of the wall 2214a. In this manner, the bracket assembly 3000 is configured to move upward or downward relative to the wall 2214a via the cooperation between the guide pins 3032 and the rails 2218. As shown in FIG. 25C, a cantilevered tab 3035 may project from a rear surface of the upright 3020. The tab 3035 is positioned such that it (and the bracket assembly 3000) is urged upward via a biasing element 3800 when the container 100 is removed from the security device 2000, as discussed in detail below.

Referring to FIGS. 19, 20, 22, and 25A, each corner section 2200, 2300 may include a plate 3050 that cooperates with a respective bracket assembly 3000 to lock a height h of the respective corner section 2200, 2300 (and thus the opening 2302 thereof), for example, to correspond with a width w (FIG. 17) of the container 100. Specifically, a plurality of teeth 3050c may formed on a rear surface of the plate 3050 and be configured to engage a plurality of teeth 2229a formed on the rails 2228a of the upper section 2220, respectively, to lock the height h of the corner section 2200 (and opening 2302) when a corner of the container 100 is extended through the opening 2302. In embodiments, the teeth 3050c may be oriented and configured to allow the upper section 2220 to be moved downward about the container 100, but restrict upward movement when the teeth 3050c engage the teeth 2229a of the upper section 2220. In the embodiment shown, the teeth 3050c of the plate 3050 engage teeth 2229a formed on rails of the upper section 2220. It is contemplated that the teeth 2229a may instead be formed on the lower section, for instance, in such embodiments where the lower section comprises rails instead.

The plate 3050 may include a protrusion 3050a projecting forward therefrom dimensioned to extend through a slot 3025 of the upright 3020. The protrusion 3050a is configured to engage a respective side of the container 100 (FIG. 17) such that protrusion 3050a (and therefore the plate 3050) is urged rearward by the container 100 from an unlocked configuration (FIG. 25B) to a locked configuration (where the teeth 3050c of the plate 3050 engage the teeth 2229a of the upper section 2220), as discussed in detail below.

A depression 3050b may be formed in the plate 3050 and be dimensioned to accommodate the retainer 3040 of the upright 3020 when the locking assembly (e.g., the plate 3500) is in the locked configuration.

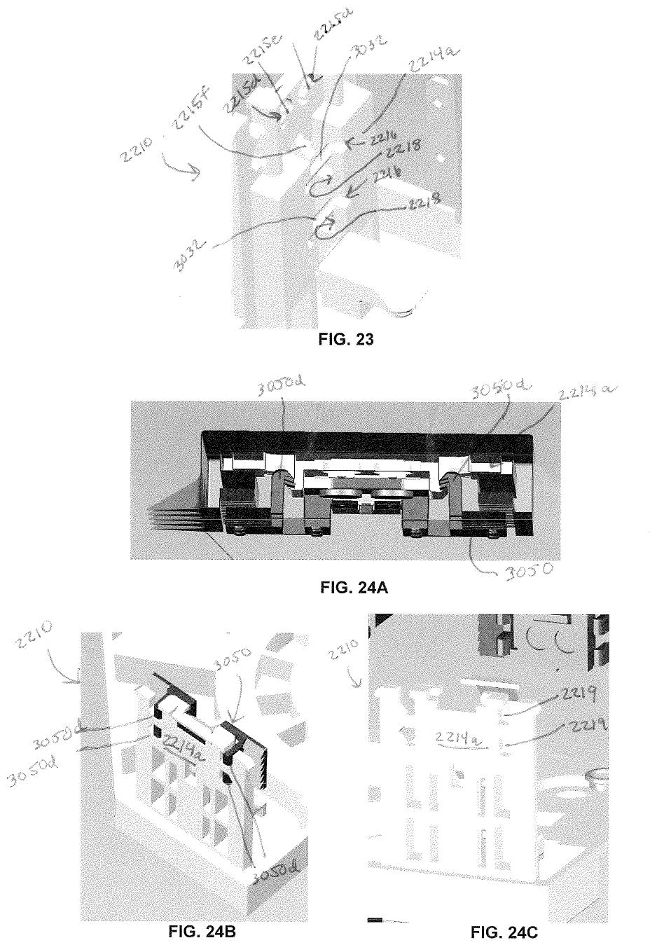

Referring to FIG. 20, the wall 2214a of the lower section 2210 may include one or more depressions 2215d dimensioned to receive biasing elements 3800 therein. The biasing elements 3800 may be configured to urge the plate 3500 from the locked configuration (FIG. 25A) to the unlocked configuration (FIG. 25B) when the container 100 is removed from the security device 2000. The depressions 2215d may include spacers or projections 2215e (FIG. 23) positioned to align with and be received by receptacles (e.g., 1240a, 1240b in FIG. 16B) formed on a rear surface of the plate 3050. The projections 2215e may serve to retain the biasing elements 3800 (FIG. 25D) in position, while also maintaining the position of the plate 3500 relative to the wall 2214a when received by the receptacles, e.g., when the plate 3050 is in the locked configuration (FIG. 25A). The wall 2214a of the lower section 2210 may define a standoff 2215f projecting forward therefrom configured to guide the plate 3050 into a locked configuration. In embodiments, the standoff 2215f may also serve to inhibit the plate 3050 from moving below a certain height.

A non-limiting example operation of the corner sections 2200, 2300 will now be described referring to the example corner section 2200 of FIGS. 18, 19, and 25A-25D. As noted above, the corner section 2200 is operable in a locked configuration (FIG. 25A) to lock or secure a respective corner 120 (FIG. 17) of the container 100 in place. Specifically, a corner 120 (FIG. 17) of the container 100 may be brought into the corner section 2200 such that it protrudes through the opening 2302 thereof, and such that the sides 150 (FIG. 18—edges thereof) are brought onto the rests 3010 (FIG. 19). The length of the back plate 2100 may be reduced such that the container 100 is sandwiched by the corner brackets 2200, e.g., by telescoping the second section 2120 (FIG. 18) of the back plate 2100 into the first section 2110 thereof. When the container 100 is sandwiched in this manner, it will engage the protrusions 3050a of the plates 3050 urging the teeth 3050c (FIG. 25A) thereof into engagement with the teeth 2229a of the upper section 2220. The upper section 2200 may be moved downward until the corner 120 (FIG. 17) is sandwiched by the upper section 2220 (e.g., the cover element 2222 thereof) and the lower section 2210 (e.g., the base surface 2212 thereof), thereby locking the respective corner of the container in place. In embodiments, moving the upper section 2200 downward in this manner will cause the container to urge the bracket assembly 3000 downward via engagement with the rest 3010 thereof such that the retainer 3040 thereof engages the depression 3050b (FIG. 20) of the plate 3050.

When the container 100 is removed from the security device 2000 (e.g., via a detacher key), the bracket assembly 3000 will be urged upward via the biasing element 3800 (FIG. 25C), and the plate 3050 will be urged forward via the other biasing elements 3800 (FIG. 25D) to disengage the plate 3050 from the upper section 2220 (FIG. 25B), whereby each corner section 2200, 2300 will assume an unlocked configuration.

Referring to FIGS. 18 and 26A-26C, additional features of the security device 2000 will now be described. As shown in FIGS. 18 and 26B, the lower sections 2210, 2310, and the back plate 2100 may include a plurality of reinforcing or stiffening ribs 2213, 2313, 2113, respectively, to increase the structural integrity of the security device 2000, for example, in such embodiments where the corner sections 2210, 2310 and the back plate 2100 are made of plastic and formed via a plastic injection process.

Opposing ends 2102, 2104 of the back plate 2100 may include a first mating structure 2117 that is shaped and dimensioned to mate with a second mating structure 2217 formed on a lower surface of the corner section 2200, e.g., on a lower surface of the base plate 2212 thereof).

In the embodiment shown, the first mating structure 2117 includes a plurality of concentric rings 2117a defining annular spaces 2117b therebetween that are dimensioned to align with and accommodate a plurality of concentric rings 2217a disposed on a lower surface of the lower section 2210. Additionally, the end 2102 of the back plate 2100 may define an annular region 2117c that is dimensioned to align with and accommodate a contoured protrusion 2217b formed on a lower surface of the corner section 2200. The concentric rings 2117a, 2217a, annular spaces 2117b, and contoured protrusion 2217b are configured such that the corner sections 2200, 2300 may pivot relative to the back plate 2100, while enhancing the structural engagement therebetween, e.g., due to their interlocking engagement making it difficult to pry a respective corner section 2200, 2300 away from the back plate 2110.

In embodiments, it is contemplated that the first mating structure 2117 and the second mating structure 2217 may be reversed. For example, the corner section 2200 may define the second mating structure 2217, and the end 2102 of the base plate 2100 may define the first mating structure 2217. It is also contemplated that the first and second mating structures 2117, 2217 may take on other shapes and forms for pivotally mating with each other without departing from the scope of the present teachings.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The designs or other configurations shall not be limited to those disclosed herein and are considered separable from the functional aspects of the present technology.

The foregoing description identifies various, non-limiting embodiments of a security device. Modifications may occur to those skilled in the art and to those who may make and use the invention. The disclosed embodiments are merely for illustrative purposes and not intended to limit the scope of the invention or the subject matter set forth in the claims.

1. A security device comprising:
a back plate having a first end and a second end;
a first corner section pivotally connected to the first end of the back plate, and a second corner section pivotally connected to the second end of the back plate, each corner section configured to receive a respective corner of an item to be secured.

2. The security device of claim 1, wherein the first and second corner sections are configured to pivot about first and second pivots disposed in a common plane.

3. The security device of claim 2, wherein the common plane is defined by a longitudinal axis of the back plate and a transverse axis perpendicular to the longitudinal axis.

4. The security device of claim 14, wherein the back plate comprises a first section and a second section, wherein the second section is telescopically received by the first section.

5. The security device of claim 14, wherein the back plate comprises a first section in sliding engagement with a second section, wherein the first section and the second section cooperate to adjust a length of the back plate.

6. The security device of claim 1-, wherein the back plate includes a locking assembly configured to lock a position of the second section relative to the first section.

7. The security device of claim 1, wherein a plurality of teeth are disposed on a surface of the second section, and a spring biased member is disposed on a surface of the first section, wherein the spring biased member is configured to engage the teeth to lock a position of the second section relative to the first section.

8. The security device of claim 7, wherein the spring biased member comprises a ferrous material that is attractable to a magnet such that the spring biased member is deflected away from the teeth when subjected to a magnetic field created by a magnet.

9. The security device of claim 1, wherein the respective corners are disposed at opposing ends of a diagonal therebetween.

10. The security device of claim 1, wherein the first corner section and the second corner section each comprise an upper section and a lower section defining an opening configured to receive the respective corner of the item to be secured.

11. The security device of claim 10, wherein one of the upper section and the lower section comprises a rail, and the other of the upper section and the lower section comprises a track or groove, wherein the rail is configured to move in the track or groove to adjust a height of the opening.

12. The security device of claim 11, wherein the corner section includes a plate comprising a first plurality of teeth, and the rail comprises a second plurality of teeth configured to engage the first plurality of teeth to lock the height of the opening.

13. The security device of claim 1, wherein the upper section slidingly engages the lower section such that a height of the respective first and second corner sections is adjustable.

14. The security device of claim 1, wherein the back plate defines a housing, said housing dimensioned to accommodate at least one of a ferrite rod, an EAS tag, an AM tag, a RF tag, a sensor, and a magnet.

15. A security device for securing a container comprising:
a back plate comprising a first end and a second end;
a first corner section removably attached to the first end and a second corner section removably attached to the second end, wherein the first corner section defines a first opening to receive a first corner of the container, and the second corner section defines a second opening to receive a second corner of the container disposed at a diagonal relative to the first corner; and
a first locking assembly configured to lock a height of the first corner section and a second locking assembly configured to lock a height of the second corner section.

16. The security device of claim 15, wherein the first and second corner sections each comprise a plurality of teeth disposed at opposite ends thereof configured to engage a container secured by the security device.

17. The security device of claim 15, wherein the first and second corner sections each include an upper section and a lower section, wherein one of the lower section and the upper section slidably receives the other of the lower section and the upper section to adjust a respective height of the first and second corner sections.

18. The security device of claim 15, wherein the first and second corner sections each include an upper section and a lower section, and wherein the first and second locking assemblies each include a plate, wherein one of the upper section and the lower section defines a first plurality of teeth and the plate defines a second plurality of teeth configured to engage the first plurality of teeth when the container is received by the security device to lock the container in place.

19. The security device of claim 18, wherein each plate includes a protrusion configured to engage the container to urge the second plurality of teeth into engagement with the first plurality of teeth.

20. The security device of claim 18, wherein the first and second locking assemblies each include a bracket assembly, wherein the plates and the bracket assemblies are respectively urged forward and upward when the container is removed from the security device to disengage the upper section from the lower section.

21. The security device of claim 20, wherein the first and second locking assemblies each include first and second biasing elements configured to respectively urge the plates and the bracket assemblies forward and upward to disengage the second plurality of teeth from the first plurality of teeth.
